(19) United States
(12) Patent Application Publication
(10) Pub. No.: US 2005/0126794 A1
(43) Pub. Date: Jun. 16, 2005

(54) Fire prevention system

(76) Inventors: Gerald R. Palmer, Phoenix, AZ (US); Timothy P. Mendoza, Phoenix, AZ (US); David D. Mettler, Scottsdale, AZ (US); James E. Paxon, Truth or Consequences, NM (US); George A. Zugmier, Scottsdale, AZ (US)

Correspondence Address: LOUIS J. HOFFMAN, P.C., 14614 NORTH KIERLAND BOULEVARD, SUITE 300, SCOTTSDALE, AZ, 85254, US

(21) Appl. No.: 10/877,966

(22) Filed: Jun. 24, 2004

Related U.S. Application Data
(60) Provisional application No. 60/529,056, filed on Dec. 12, 2003.

(51) Int. Cl. A62C 35/00

(52) U.S. Cl. 169/16; 239/145; 169/45; 169/49

(57) ABSTRACT

A disclosed fire retardant application structure includes an elongated tube comprised of material that is water-porous throughout on one side of the tube and material that is water-impermeable on the remainder of the tube. A disclosed wildfire monitoring and service system includes a satellite-image monitoring computer that is programmed to display a composite map image defining locations of wildfires observed by satellite and multiple separate structures. The system also includes a wireless transmission subsystem that is capable of transmitting a signal from the central location to each of the structures selectively, and, at each of the structures, a fire-retardant application subsystem. Each of the application systems is directed at exterior surfaces of its respective structure and is responsive to a select signal that is transmitted through the transmission system. Variations and methods are also disclosed.

### CROSS REFERENCE TO RELATED APPLICATIONS

This application claims benefit of U.S. Provisional Application No. 60/529,056 filed Dec. 12, 2003, which is incorporated herein by reference.

### BACKGROUND OF THE INVENTION

Homes and other structures erected in wooded areas face a significant danger of being lost or severely damaged due to wildfires, especially when the surrounding woodlands are suffering from drought conditions. Such structures are frequently evacuated in the face of an approaching forest fire and thus are least protected by the opportunity for human intervention when the danger is greatest. In addition, vacation homes (which often represent a sizable proportion of the structures found in a given heavily forested area) are typically vacant during the week and thus are most likely to be unoccupied should a forest fire break out in the area, regardless of whether an evacuation is happening or not.

It is well known to apply water or some other type of retardant to a structure to prevent it from catching fire. For example, U.S. Pat. No. 5,165,482 to Smagac et al. discloses a fire deterrent system for structures in a wildfire hazard area. In Smagac's system, spray-type sprinklers and seeper hoses can apply fire retardant fluid such as water to a structure and surrounding vegetation in advance of a determined arrival of a fire. However, the terrestrial fire sensors employed can only determine wildfire danger within a limited distance from the structure.

U.S. Pat. No. 4,330,040 to Ence et al. discloses a fire prevention and cooling system that employs a dispensing tube adjacent to a wall and under an eave of a structure. The dispensing tube includes spaced openings, e.g., of 0.069 inch size, formed longitudinally along the tube in multiple parallel paths. As illustrated in Ence's FIG. 9, the dispensing tube is positioned such that its water spray covers the wall and the eave immediately adjacent to the wall, and also a portion of an extended eave that may lie at a distance from the wall. The dispersal of water by that method is relatively inefficient, however, because sprayed water evaporates quickly (especially in the low-humidity conditions in which wildfire danger is the worst) and a considerable portion of the spray is likely to miss the wall and eave entirely.

Thus, despite the the disclosure of the Smagac and Ence patents and other references, the need remains for improvements in water-use efficiency and for a way of preventively applying fire retardant based on the detection of distant fires.

### SUMMARY OF THE INVENTION

A fire retardant application structure according to various aspects of the present invention includes an elongated tube comprised of material that is water-porous throughout on one side of the tube and material that is water-impermeable on the remainder of the tube. Advantageously, fire retardant pressurized inside the tube can cover a wall to which the tube is attached without spraying through the air and without being dispersed away from the wall.

A wildfire monitoring and service system according to various aspects of the present invention includes a satellite-image monitoring computer that is programmed to display a composite map image defining locations of wildfires observed by satellite and multiple separate structures. The system also includes a wireless transmission subsystem that is capable of transmitting a signal from the central location to each of the structures selectively and, at each of the structures, a fire-retardant application subsystem. Each of the application systems is directed at exterior surfaces of its respective structure and is responsive to a select signal that is transmitted through the transmission system.

By observing fires from a satellite and taking preventive action based on those observations, the system can protect structures from fire danger even when that danger is not apparent by human or automatic observation at the structure itself. By transmitting signals selectively, the system can active its fire-retardant application subsystems only at selected structures, avoiding unnecessary retardant applications at other structures.

The above summary does not include an exhaustive list of all aspects of the present invention. Indeed, the inventors contemplate that the invention includes all systems and methods that can be practiced from all suitable combinations of the various aspects summarized above, as well as those disclosed in the detailed description below and particularly pointed out in the claims filed with the application. Such combinations have particular advantages not specifically recited in the above summary.

### BRIEF DESCRIPTION OF THE DRAWINGS

FIG. 1 is a schematic view of a fire prevention system according to various aspects of the present invention in operation to protect a structure.

FIG. 2 is a schematic block diagram of a fire retardant distribution station of the system of FIG. 1.

FIG. 3 is a cutaway perspective view of a porous pipe of the system of FIG. 1 in operation mounted on a wall of the structure being protected.

FIG. 4 is a cutaway end view of the porous pipe of FIG. 3.

FIG. 5 is a cutaway side view of a pressure reducer employed in the fire retardant distribution station of FIG. 2.

FIG. 6 illustrates top and side views of the pressure reducer of FIG. 5.

FIG. 7 is an exploded side view of a retardant injector employed in the fire retardant distribution station of FIG. 2.

FIG. 8 is a flow diagram of a fire prevention method of the invention employing the system of FIG. 1.

FIG. 9 is a perspective view of the structure that FIG. 1 illustrates schematically.

FIG. 10 is a perspective view of a particularly advantageous type of sprayer for use in the fire retardant distribution station of FIG. 2.

FIG. 11 is a perspective view of a water vein of the sprayer of FIG. 10 having an inverted spillway according to various aspects of the invention.

### DESCRIPTION OF PREFERRED EXEMPLARY EMBODIMENTS

A portion of this specification resides within the appendices of provisional application Ser. No. 60/529,056, which is referred to herein as the '056 application. The appendices, as with the rest of the '056 application, are incorporated herein by reference.

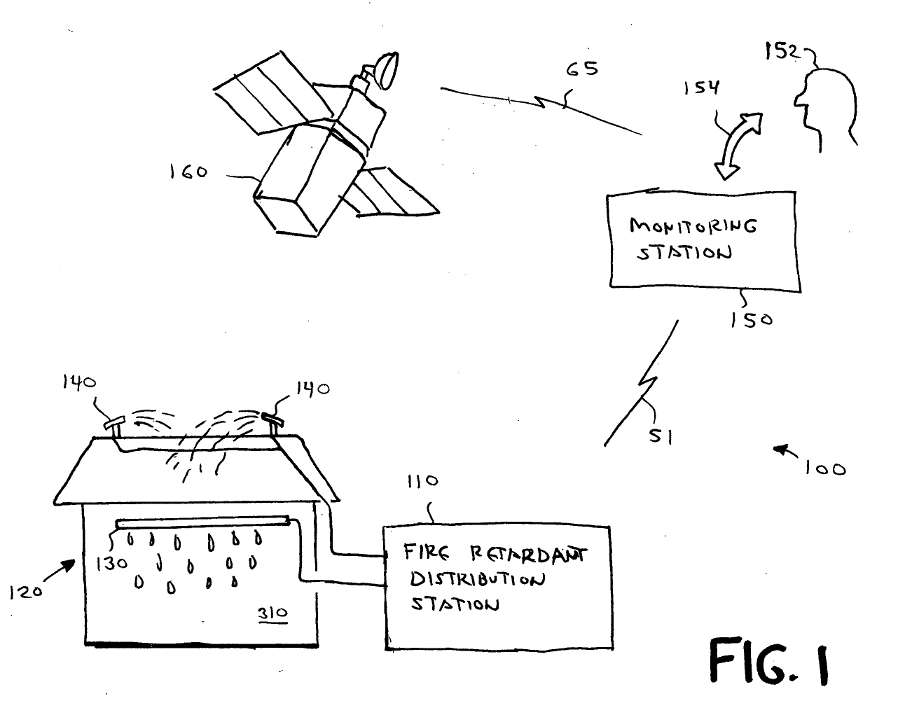

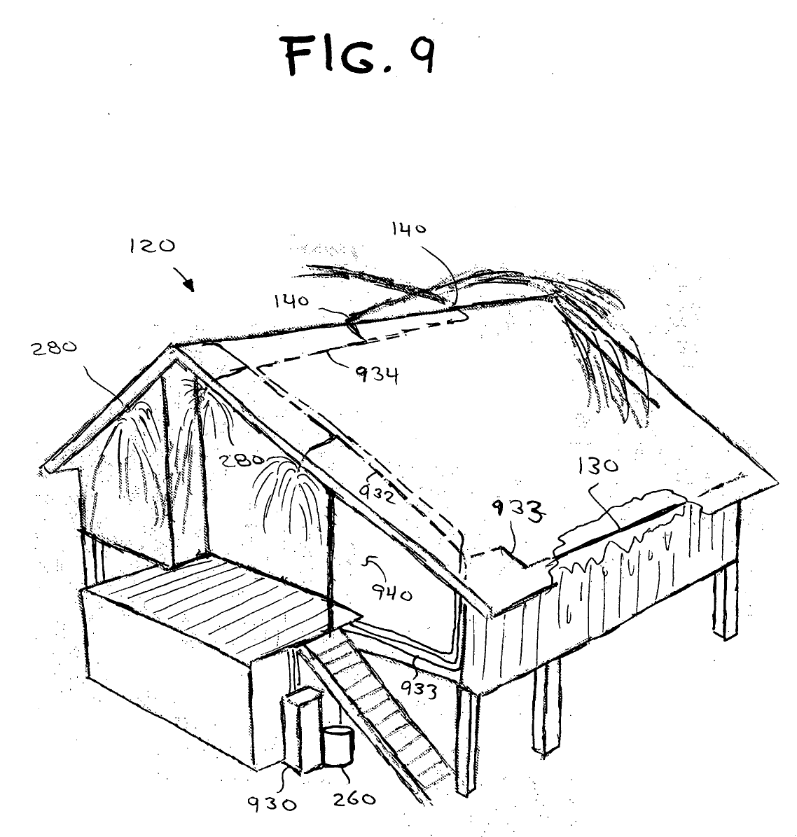

A fire prevention system according to various aspects of the invention provides numerous benefits, including efficient use of fire retardant when and where needed for effective protection of a structure. As may be better understood with reference to the simplified diagram of FIG. 1, exemplary fire prevention system 100 includes: a fire retardant distribution station 110; sprinklers 140; a porous pipe 130 attached to a building 120 being protected from fire; and a monitoring station 150 in communication with distribution station 110 via a wide-area connection 51. (FIG. 9 is a perspective view of structure 120 illustrating a cabinet 930 that houses various other components of distribution station 110 as discussed below.)

Monitoring station 150 obtains image data from a satellite 160 through a wireless connection and one or more intermediate data processing stations, all of which are represented by connection 65. Station 150 interacts with a human operator 152 via conventional user interface hardware and software (e.g., mouse, keyboard, display, GUI code) represented by arrow 154.

Monitoring station 150 determines, autonomously or with judgment of operator 152, if image data from satellite 160 (suitably processed as discussed below) indicates an alert condition that would make it prudent to take action intended to improve protection of structure 120 against an approaching fire. Upon detection of the alert condition, specifically, station 150 generates a signal that transmits via connection 51 to distribution station 110. In response to receipt of the signal, distribution station 110 activates distribution of a fire retardant mixture onto or near structure 120.

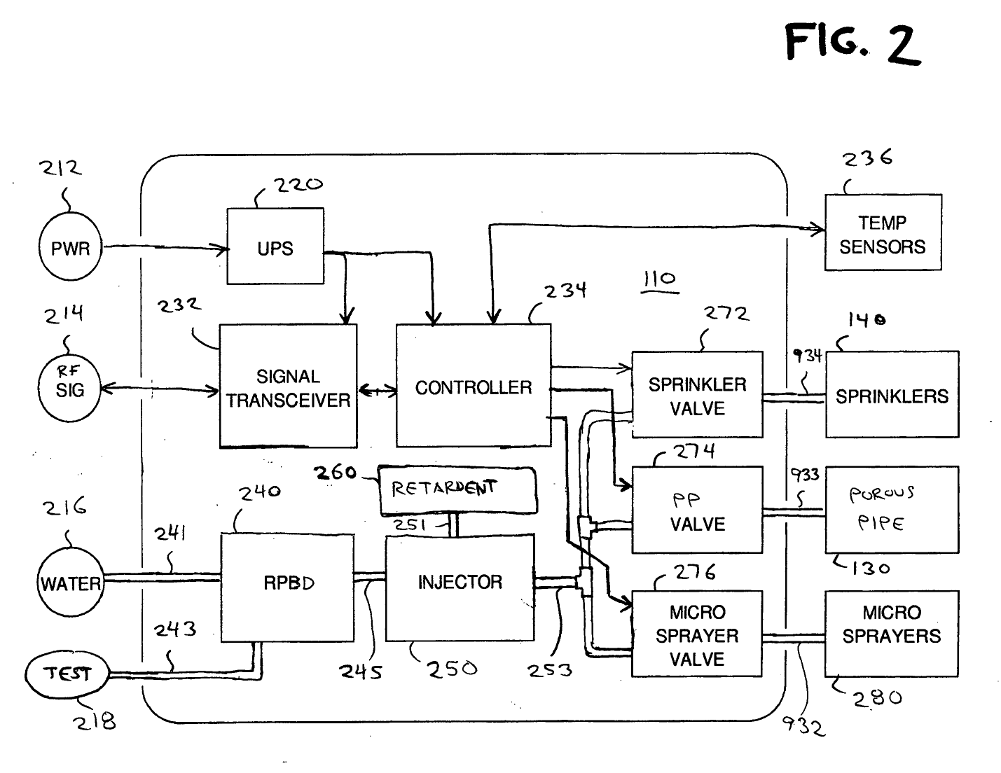

As may be better understood with reference to FIG. 9, exemplary fire retardant distribution station 110 includes a cabinet 930, which houses various components. These components, illustrated schematically by FIG. 2, include an electrical subsystem having a number of components: an uninterruptible power supply (UPS) 220 capable of operating off of an external source 212 of electrical power or batteries (not shown) in the absence of regular electrical power; a signal transceiver 232 establishing link 51 (FIG. 1) via received and transmitted RF signals 214; and a controller 234. UPS 220 supplies electrical power to signal transceiver 232 and controller 234, which suitably supplies operating power to temperature sensors 236. Responsive to activation instructions received via transceiver 232, controller 234 supplies activating power to valves 272-276. In a variation, controller 234 supplies signals that activate fluid flow, causing hydraulic triggering of valves 272-276.

Distribution station 110 further includes a number of plumbing components that also reside in cabinet 930, including a reduced-pressure backflow device (RPBD) 240 having access to a water supply 216 via tubing 241; an injector 250, coupled to RPBD 240 at its reduced-pressure output port via tubing 245 and to a reservoir 260 of retardant via tubing 251, to supply a water-retardant mixture to a tubing network 253 (extending to the right in FIG. 2); a sprinkler valve 272 (or several such valves) selectively coupling the mixture from network 253 to sprinklers 140 (FIGS. 1, 9) via tubing 934; a porous pipe valve 274 (or several such valves) selectably coupling the mixture from network 253 to porous pipes 130 (FIGS. 1, 3-4) via tubing 933; and a micro sprayer valve 276 (or several such valves) selectably coupling the mixture from network 253 to micro sprayers 280 (FIG. 9) via tubing 932.

Valves 272, 274, 276 can selectably couple retardant mixture to their various downstream structures in any suitable manner, for example by employing a solenoid and valve combination that provides a fluid passage when electrically switched into an “open” mode and obstructs passage of fluid when electrically switched to a “closed” mode. Suitable electrically activated, data-latching solenoid valves and actuators are available from Evolutionary Concepts, Inc. (www.ecivalves.com) of San Dimas, Calif.

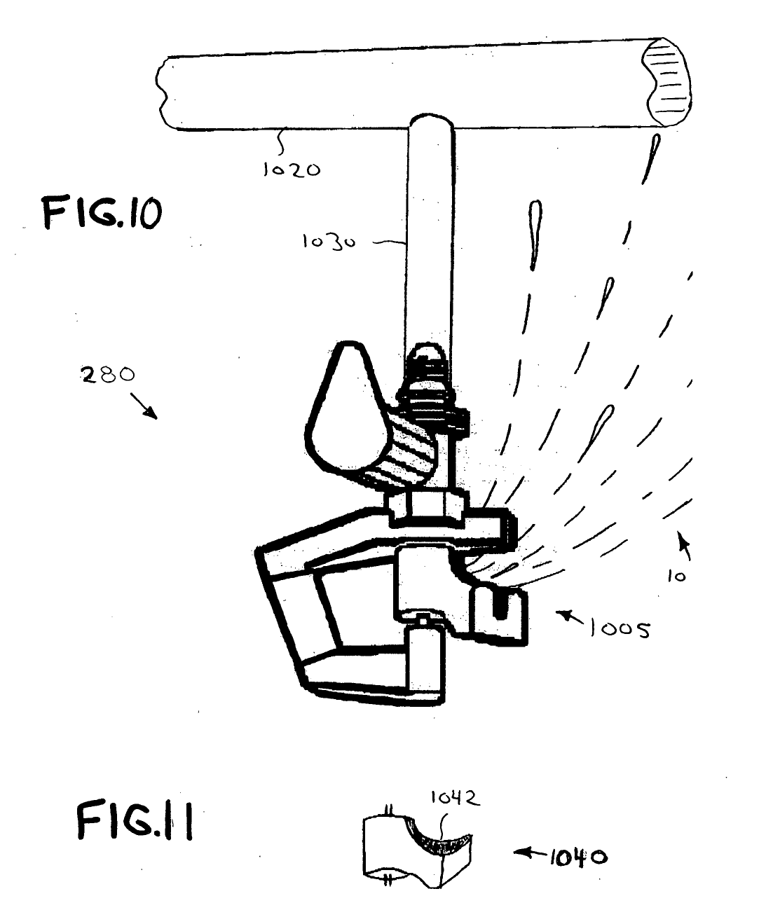

Micro sprayers 280, a preferred embodiment of which is illustrated in FIG. 10, advantageously direct their spray upward so that the sprayed retardant has more opportunity to contact the wall near which it is installed, e.g., wall 940 of FIG. 9. Micro sprayer 280 has a spray head 1005 suspended upside down from an overhead water main 1020, to which it fluidly couples via a connecting pipe 1030. The spillway 1042 of the water vein 1040 (FIG. 11) in head 1005 is inverted from the normal spray head configuration (which would direct spray downward) to direct the spray upward. FIG. 10 illustrates the upward spray with schematically depicted water droplets 1040.

Exemplary reservoir 260 of FIG. 2 has a tank with a capacity in the 30-45 gallon range that can be housed inside cabinet 930 or, as illustrated in FIG. 9, sit next to cabinet 930. Advantageously, reservoir 260 provides a base level of retardant that can still be applied under battery power if the main supply of electricity (which drives any well pump employed in the water supply) is cut off. Cabinet 930 can have any suitable dimensions, e.g., 70 by 30 by 18 inches, and can be mounted in any suitable manner, e.g., by being bolted or otherwise attached to building 120.

A signal transceiver according to various aspects of the invention, e.g., transceiver 232 of distribution station 110 (FIG. 2), can be of any type suitable for communicating with a monitoring station (e.g., monitoring station 150 of FIG. 1) to receive a signal directing the application of retardant to a structure. Preferably, the transceiver also transmits information about fire conditions back to the monitoring station. An example of a suitable transceiver is the “Uplink DigiCell 1500 Universal Alarm Transceiver” sold by Uplink Security (www.nmrx.com) of Atlanta, Ga.

Tubing according to various aspects of the invention includes any structure suitable for channeling fluid from one place to another. For example, tubing 241, 245, 251, 253, 832, 934 can be conventional plastic tubing commonly employed for irrigation, flexible vinyl hose, rigid PVC pipe, etc.

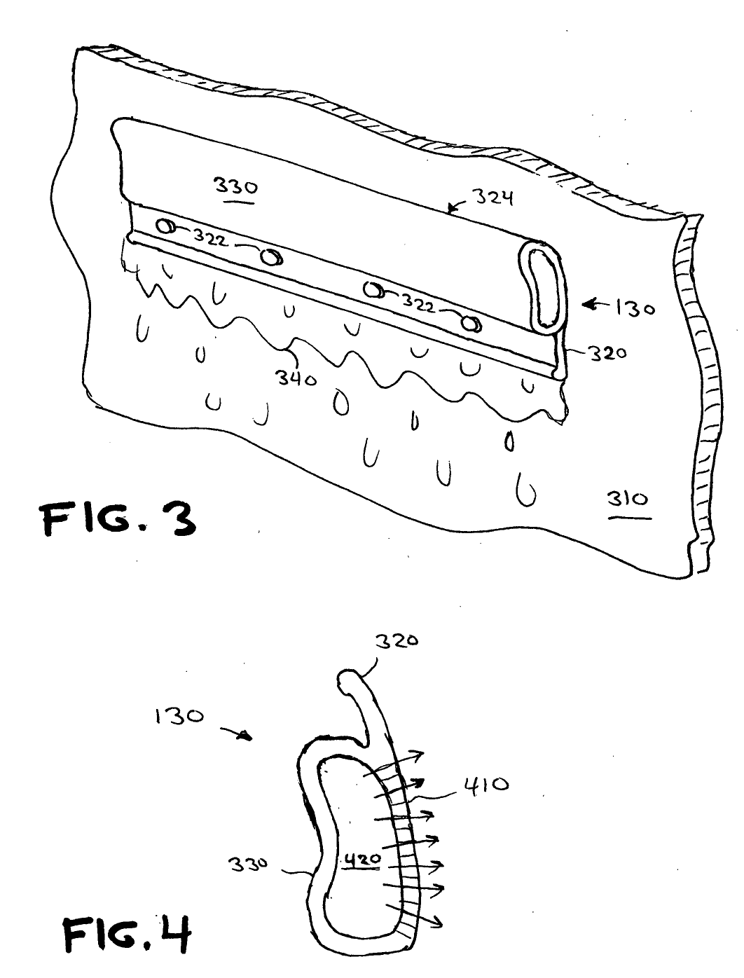

FIG. 3 illustrates a section of exemplary pipe 130 mounted on a wall 310 of structure 120 (FIG. 1). Pipe 130 includes a tubing portion 324 and a mounting lip 320, preferably fabricated as an integral structure from a suitable fluid-porous material. Tubing portion 324 has a generally elliptical cross-section that is indented on one side 330 to maintain structural integrity under pressure and for aesthetic appearance.

Mounting lip 320 has a suitable width (e.g., 1 cm) and thickness (e.g., 3 mm) to support the weight of pipe 130 and contained fluid on wall 310 with conventional nails 322 (e.g., from a nail gun) or staples (not shown). By including lip 320, pipe 130 thus can be mounted without having its shape deformed by fasteners around its tubing portion 324. The front face of lip 320 and front wall 330 can be painted to match the color of wall 310 or to provide aesthetic accent. The pipe 130 can be mounted upside-down from the way shown in FIG. 3, if desired.

A particularly advantageous composition of pipe 130 includes an approximately even blend of granulated tire rubber and linear low density polyethylene (e.g., 65% rubber), with carbon black added as an ultraviolet light inhibitor. The mixture can be extruded at an elevated temperature and allowed to harden into lengths of semi-flexible porous pipe.

The pipe is partially porous. In a preferred embodiment, the polyethylene regulates the porosity of the pipe in addition to serving as a binder for the granules of tire rubber. Because hardened polyethylene itself is fluid-impermeable, increasing the amount of polyethylene in the rubber-polyethylene blend reduces the permeability of the resulting pipe. Thus, the specific ratio of polyethylene versus rubber in the blend can be adjusted for a desired amount of porosity, given the water pressure and seepage requirements of a particular implementation.

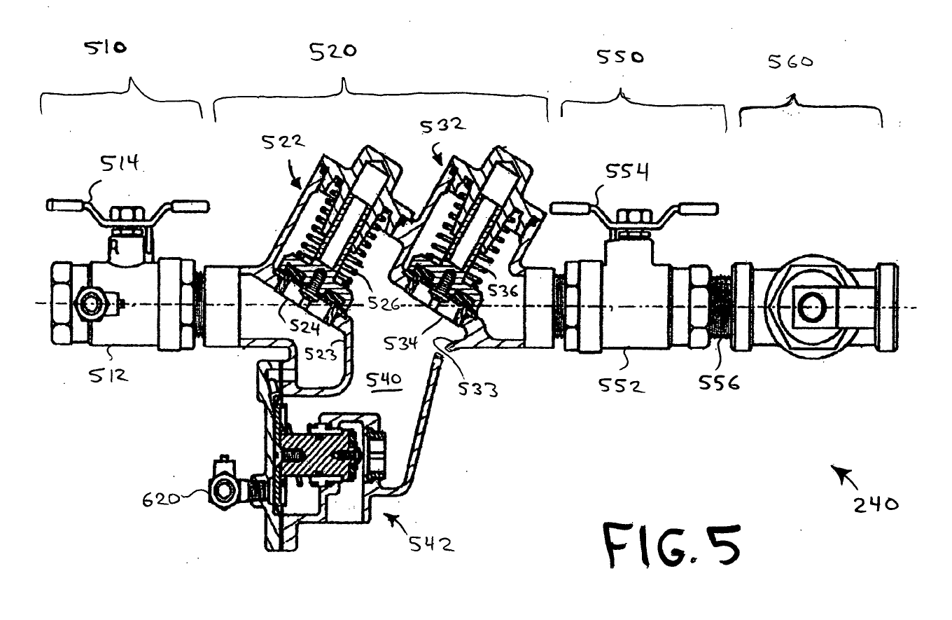

Front wall 330 of porous pipe 130 is advantageously made fluid-impermeable with a coating of the same type of linear low-density polyethylene employed in the polyethylene-rubber blend of pipe 130. Back wall 410 (FIG. 4) is left uncoated and fluid-porous, permitting retardant mixture 420 to escape through interstices between rubber granules of back wall 410, as FIG. 4 represents with arrows leading from retardant 420 inside pipe 130 to the exterior behind wall 410. It is particularly desirable to have about 54% of the circumference of tubing portion 324 coated with polyethylene. Having one half of the circumference coated is suboptimal because tubing portion 324 assumes a rounded shape when pressurized, and a significant amount of the non-coated half is not in direct contact with the wall.

Further information pertinent to making and using porous pipe according to various aspects of the invention is found in the detailed description portions of U.S. Pat. No. 5,876,387 (“Method of Forming Stabilized Porous Pipe”); U.S. Pat. No. 5,474,398 (“Stabilized Porous Pipe”); U.S. Pat. No. 5,445,875 (“Method of Forming U.V. Stabilized Porous Pipe”); and U.S. Pat. No. 5,299,985 (“Stabilized Porous Pipe”), which are incorporated herein by reference.

A reduced-pressure backflow device according to various aspects of the invention includes a particularly advantageous combination of backflow preventer and pressure reducer in series. As may be better understood with reference to FIG. 5, exemplary reduced-pressure backflow device (RPBD) 240 includes: a manual inlet valve 510 with a body 512 and handle 514; a backflow prevention portion 520 containing a pair of sequential backflow valves 522, 532 separated by a reservoir 540; a manual outlet valve 550 with a body 552 and handle 554; and a pressure reducer 560.

Backflow valves 522, 532 include respective stoppers 524, 534 mounted on compression springs 526, 536. Spring 526 keeps stopper 524 pushed against a wall 523 separating reservoir 540 from body 512 of inlet valve 510 unless the pressure differential between fluid in those two bodies is sufficient to overcome compression resistance of spring 526. Similarly, spring 536 keeps stopper 534 pushed against a wall 533 separating reservoir 540 from body 552 of outlet valve 550 unless the pressure differential there is sufficient to overcome compression resistance of spring 536. In one embodiment, the pressure differential for each spring is about 22 PSI.

When valves 510, 550 are open and fluid is present in body 512 of inlet valve 510 at pressure greater than the combined compression resistance of springs 526, 536, some of the fluid will emerge at outlet valve 550. As fluid emerges, some back pressure will develop in body 552 of outlet valve 550 from fluid resistance arising from fluid flow in the structure downstream of outlet valve 550. That structure includes drainage tap 560 and items illustrated schematically in FIG. 2, namely injector 250, valves 272-276, and retardant distribution structures like sprinklers 140. Failure of the water supply at inlet valve 510 or a blockage in the tubing downstream of outlet valve 560 can cause the difference between that back pressure and the inlet pressure in body 512 to approach or equal the combined compression resistance of springs 526, 536. In such an event, springs 526, 536 close and fluid communication breaks between inlet valve 510 and outlet valve 550.

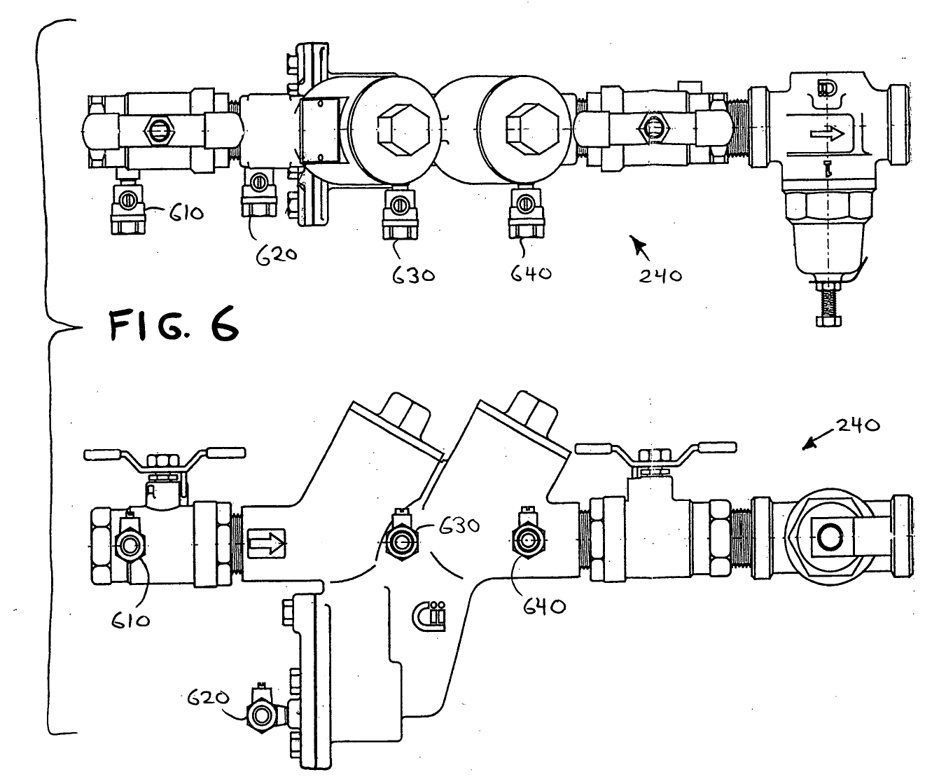

Advantageously, RPBD 240 includes petcocks 610, 620, 630, 640 (FIG. 6) along one side. RPBD 240 can be mounted in a housing (e.g., cabinet 930 of FIG. 9) and still be tested, as required annually by some municipalities, without the need for removal from the housing.

Reservoir 540 (FIG. 5) has adequate depth and a suitably designed cross-sectional shape to minimize the possibility of any fluid splashing or otherwise migrating from outlet valve 550 to inlet valve 510. If pressure remains at outlet valve 550 for some unforeseen reason, petcock 620 at the bottom area 542 of reservoir 540 can open and allow the potentially contaminated fluid to bleed out of all the tubing structure that resides downstream of outlet valve 550. With those safeguards, the water supply upstream of inlet valve 510 is strongly protected from contamination by retardant in reservoir 260 (FIG. 2).

Pressure reducer 560 is a device that regulates the fluid pressure at its outlet at a substantially fixed value despite fluctuations within an acceptable range of input fluid pressures. For example, pressure reducer 560 is preferably set to maintain a substantially fixed pressure of 30 PSI.

A type of reduced-pressure backflow device with a design that can be modified (with side-mounted petcocks) to conform with the design of backflow prevention portion 520 is presently available from Conbraco Industries, Inc. of Matthews, N.C., in the one-inch 40-200 series. That company also supplies, separately, a one-inch 36C-Series pressure reducing valve that can be employed for pressure reducer 560. When the Conbraco device is employed for pressure reducer 560, the pressure at inlet valve 510 should be kept no greater than 175 PSI and the temperature no greater than 180° F.

In exemplary system 100, injector 250 produces a water-retardant mixture with about a 3% concentration of retardant. The mixture can be combined with class A foam (e.g., at 12% concentration) and a corrosion inhibitor (e.g., at 3% concentration). The retardant is formulated to be visually clear, to avoid defacing the structure and surrounding landscape. It is also formulated to have a “sticky” or viscous type of dispersal rather then a rapid flow like water, to help it adhere somewhat to surfaces to be protected rather than quickly drain into or onto the ground. The retardant material itself is preferably a fertilizer with high phosphate content, e.g., a 10-35-0 type fertilizer.

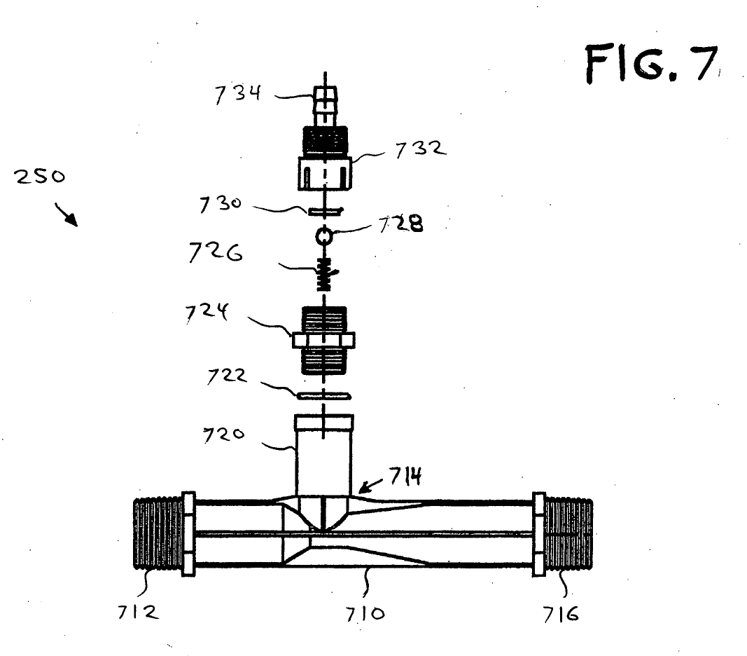

As may be better understood with reference to FIG. 7, exemplary injector 250 includes a rigid section of tubing 710 having opposite threaded ends 712, 716 and a “T” junction 714 approximately midway between them. A threaded ball valve receptacle 724 screws into a short stub 720 of tubing leading from junction 714, sealed with an “O” ring 722. Receptacle 724 receives a compression spring 726 and a ball 728, held in place by a gasket 730 and an end cap 732. End cap 732 terminates in a coupling 734 for flexible tubing 251 (FIG. 2), which leads from the source of retardant, reservoir 260 (FIG. 2).

When water flows through tubing 710 at pressure limited by RPBD 240 to approximately 30 PSI, the Bernoulli effect creates suction at stub 720, pulling ball 728 away from end cap 732 and opening a path for retardant to flow from reservoir 260 (FIG. 2) through coupling 734 and into the water stream passing out of end 716. When the flow of water is cut off, by activation of valves 272-276 or exhaustion of water supply 216 (FIG. 2), the suction at stub 720 disappears, and compression spring 726 pushes ball 728 into a receptacle (not shown) in end cap 732, cutting off fluid communication to retardant reservoir 260.

A suitable type of injector to serve as injector 250 is the Model 1078 marketed by Mazzei Injector Corp. (www.mazzei.net) of Bakersfield, Calif., preferably with a suction orifice that is configured to accommodate the specific density of retardant being used. Further information about the Mazzei injector can be found in U.S. Pat. No. 5,863,128, incorporated herein by reference.

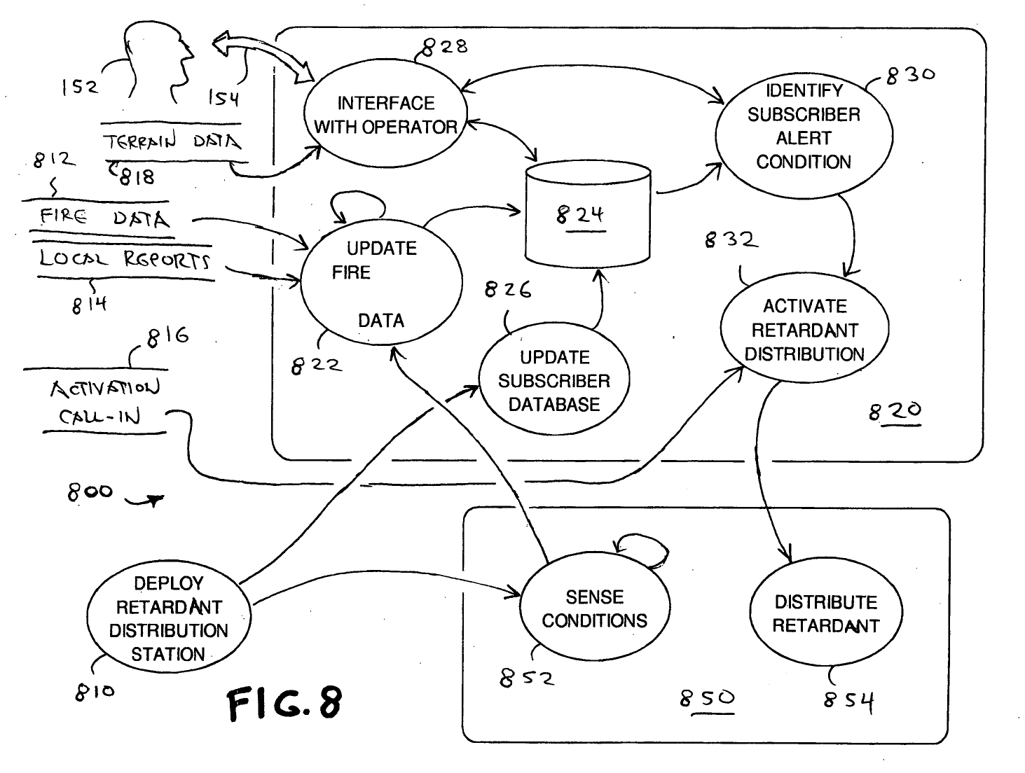

An exemplary method 800 of the invention for combating fire, e.g., with system 100 of FIG. 1, may be better understood with reference to the flow diagram of FIG. 8. At process 810, workers deploy retardant distribution station 110 of FIG. 1, install cabinet 930 (FIG. 9) alongside structure 120, and install sprinklers 140, porous pipe 130, and micro sprayers 280 (FIGS. 1-4, 9) on structure 120. With station 110 deployed, a process group 820 can commence monitoring activities at monitoring station 150 (FIG. 1), and another process group 850 is ready for activities at distribution station 110.

The various operations performed by processes of group 820 include interfacing with operator 152 at process 828, updating fire data in a data store 824 at process 822, and updating subscriber data in data store 824 at process 826. In an exemplary implementation of method 800 discussed below, fire data and subscriber data reside on separate computer servers. However, FIG. 8 depicts the data as residing in a common data store 824 for clarity of illustration.

An operator interface process according to various aspects of the invention can be implemented with any combination of hardware and software suitable for presenting information relating to possible fire alerts to an operator and obtaining direction from the operator to establish that a fire alert condition is present or to take other appropriate action. For example, process 828 is implemented by a suitable client and server combination that renders a conventional image display and solicits form input (e.g., radio buttons, check boxes, text fields).

One server (not shown) includes a conventional computer hardware and software combination implementing a middleware application known as “Fusion LT,” which is described in Appendix C of the '056 application. The Fusion LT server receives terrain data 818 from a remotely located terrain visualization server known as a “Keyhole” server (see www.keyhole.com) and overlays it with (1) fire data, e.g., from the U.S. Government-operated Hazard Mapping System (HMS), and (2) subscriber data from a local database server, e.g., running the mySQL software, that is suitably accessible, e.g., via a UNIX domain socket, a dedicated TCP port, and/or a web server (e.g., running the Apache and PHP software). The database server can run on the same computer as the Fusion LT server or on a locally-networked computer of its own.

Process 826 updates the subscriber data with GPS-derived latitude and longitude, owner or responsible party name, phone number, and address information when a retardant distribution station is employed, e.g., at process 810. Some of this information can be omitted when not needed, and additional information can be included such as height (typically available from the same GPS device that provides latitude and longitude) and neighbor's contact information.

The client (not shown) employed at process 828 includes a conventional computer hardware and software combination implementing a Keyhole client, display screen with graphics subsystem, and a human-interface device subsystem with associated peripheral hardware, all of which are conventional and represented in FIGS. 1, 8 by arrow 154. Operator 152 interacts with the Fusion LT server via the client over a local, regular network or encrypted network (e.g., with SSH tunneling) connection via the Keyhole client, display screen with graphics subsystem, and human-interface device subsystem.

When an alert condition is identified at process 830, e.g., by a decision ultimately made by operator 152 as discussed above, or by computer, process 832 activates the distribution of retardant by sending a suitable transmission to fire retardant distribution station 110 at a particular structure over communications link 51 (FIG. 1). In response, station 110 distributes the retardant, implementing process 854 of group 850.

Process 850 can include several acts that are carried out sequentially in any desired manner that enhances fire protection for a given amount of available retardant. In one example, there is sufficient retardant for three treatments. Each treatment involves separate dispersal structures (all illustrated in FIG. 9) with separate activation times. In one embodiment, the treatments can be custom activated on-site by a local operator. Sprinklers, which treat the structure's roof and surrounding landscape, including perhaps decks or lumber piles, or even nearby trees, can also be automatically activated for a first period, e.g., 10 minutes, when fire is determined to be 3-5 miles from the structure and moving toward it. That treatment protects against flying embers, a hazard discussed in Appendix E of the '056 application.

Then the porous pipe(s) soak the walls of the structure. That period can also be 10 minutes, for example, either simultaneously, sequentially, or overlapped. The next treatment is with micro sprayers 280, which can protect decks and other horizontal structures in addition to vertical structures, also optionally for 10 minutes, particularly the undersides of such components, such as the eaves shown in FIG. 9.

Especially in large structures, it can be advantageous to plumb the system to allow for several stations, with treatments within the three periods described above having sub-steps during which one station addressing only part of the structure is activated in turn. In that manner, it is possible to create a rotating sequence of station activations. For the protection of large structures, it can be advantageous to use separate, independently operating systems using duplicates of the components illustrated in FIG. 2.

After activation of retardant distribution by monitoring station 150, or even without any such activation, detection of a temperature above a predetermined threshold, e.g., 137° F., can automatically initiate a second treatment or cycle of treatments. Temperature sensors 236 are mounted on sides of the structure to perform such detection. The system can be customized to allow activation of a particular station controlling a particular side of the structure only if one of the several temperature sensors exceed the threshold at a particular time. A third activation (or more, if the supply of retardant is sufficient) can occur at a predetermined time after conclusion of the second activation, or alternatively based on some predetermined pattern of temperature changes. An example of such a pattern is a drop in temperature followed by a rise in temperature. That pattern might occur if two low-brush types of fire occurred in sequence, or if a fire front passed nearby and was followed by a low-brush type of fire.

Performance is best when plenty of water is available for mixing with retardant, for example between 250-500 gallons per treatment sequence. The dispersal of a large amount of water provides a “humidity envelope” that surrounds and thus protects the structure. When well flow capacity is limited, a water reservoir (often required by local ordinance) can be included for the desired water supply.

Station 110 can also implement process 852 of group 850, sensing fire conditions and reporting back to fire data updating process 822 of monitoring station 150. For example, a number of subscribers can report on local temperatures to a single monitoring station, which can use differentials between local temperatures to further refine its estimate about fire location and direction of movement.

Various particular features of exemplary system 100 may be better understood with reference to the labeled paragraphs below. In variations where the benefits of these particular features are not required, they may be suitably omitted or modified while retaining the benefits of the various aspects of the invention discussed above. With possible exceptions, structural elements not introduced with a reference numeral are not illustrated in the drawings.

IMAGE ANALYSIS AND MAPPING—System 100 (FIG. 1) employs satellite data to monitor for fire alert conditions. A fire alert according to various aspects of the invention is a condition that makes it prudent to protect a structure against fire by distributing retardant onto the structure. The prudence of distributing a potentially limited supply of retardant is evaluated based on the danger presented by a nearby fire. Additional factors can be considered, such as the supply of retardant, the direction of movement of the fire (e.g., using the FARSITE fire area simulator), and the size and rate of growth of the fire.

System 100 can employ satellite data captured by the Satellite Services Division (SSD) of the National Oceanic and Atmospheric Administration (NOAA), both of which are government agencies. The captured satellite data is collected from four satellite sources and is manually integrated into a single mapping layer known as the Hazard Mapping System (referred to herein as “HMS”). The manual integration process helps remove false detects from the raw data of the various satellite sources.

The four data sources used by the satellite analysis are: (1) WF-ABBA—Wildfire Automated Biomass Burning Algorithm; (2) FIMMA—Fire Identification Mapping and Monitoring Algorithm; (3) MODIS—Moderate Resolution Imaging Spectroradiometer Fire Algorithm; and (4) DMSP/OLS—Defense Meteorological Satellite Program Operational Linescan System Nighttime Lights Algorithm.

The HMS web page warns as follows regarding the usage of published fire data: “The information on fire position should be used as a general guidance and for strategic planning. Tactical decisions, such as the activation of a response to fight these fires, should not be made without other information to corroborate the fire's existence and location.” Additional quoted material that may be instructive about HMS are found in Appendix A of the '056 application.

DATA ACQUISITION—Appendix A of the '056 application contains information about an exemplary software architecture for receiving HMS Geographic Information System (GIS) shape file data when it is available from NOAA. The Fusion LT system converts the GIS shape file data into its own database format used by the local Keyhole server. This local Keyhole server database is then used as an overlay to an existing Keyhole bitmap geographical image server database, e.g., at the vendor's location in California. To avoid adversely affecting system performance, the Fusion LT database can be set to only update when the HMS data has changed.

The same Fusion LT middleware application can be employed to process latitude and longitude coordinates of customer locations directly from data store 824 (FIG. 8). Updates can occur at midnight each day to avoid affecting local server performance. The process can be made transparent so that customer data only needs to be entered once in data store 824.

Once latitude and longitude coordinates of each customer property location have been acquired, e.g., via a portable Global Positioning System (GPS) unit, operators obtain access to most database fields stored in data store 824. These fields can be displayed as interactive “hot links” with customer data such as customer name, phone number, and important geographic location information.

SPACE IMAGING OPTIONS—Appendix B of the '056 application describes various options for analyzing space images to determine presence of fire alert conditions. Briefly, vendor solutions such as the “Fire Behavior Modeling Application” offered by Space Imaging and the Firemapper® system offered at www.firemapper.com can be employed.

MANUAL, ASSISTED, OR AUTOMATED ALERT ANALYSIS—The ultimate decision about whether a fire alert exists or not, and consequently whether or not to activate distribution of retardant, can be made by a human operator after evaluation of raw or partially analyzed data (e.g., seeing fires near “hot link” icons representing structures under protection) or based on a computer-generated recommendation. For example, an operator at monitoring station 150 (FIG. 1) can note when a fire is within a given distance (e.g., 2 miles, 5 miles, 10 miles) of structure 120 and either activate fire retardant distribution station 110 to begin a process of retardant distribution or alert a local operator in a region (e.g., a county) responsible for structure 120, who can make the ultimate decision about activation based on his or her additional local observations. The local operator can soon find out if the satellite-based preliminary alert proves unfounded, e.g., because the 1 km resolution of the GIS-based data from the HMS product was unable to tell that the fire was only a property owner's 10 foot by 10 foot slash fire. In systems where the accuracy of an automated alert analysis and detection system is sufficient given the cost of unnecessary retardant distribution, the need for a decision by a human operator can be eliminated.

At any place in the detailed description of preferred exemplary embodiments above where the detailed description portions of a patent or publicly accessible document is mentioned, the contents of that document are hereby incorporated herein by reference. The detailed description portions of all U.S. patents and patent applications incorporated by reference into such documents are also specifically incorporated herein by reference.

### PUBLIC NOTICE REGARDING THE SCOPE OF THE INVENTION AND CLAIMS

The description above is largely directed to preferred exemplary embodiments of the invention. Specificity of language and statements of advantageous performance do not imply any commensurate limitation on the scope of the invention, nor do they require the stated performance. Portions of the application introducing structural and method elements of the various inventions should be understood as including broadening terminology such as “preferably,” “in a variation,” “in one embodiment,” etc.

No one embodiment disclosed herein is essential to the practice of another unless indicated as such. Indeed, the invention, as supported by the disclosure above, includes all systems and methods that can be practiced from all suitable combinations of the various aspects disclosed, and all suitable combinations of the exemplary elements listed. Such combinations have particular advantages, including advantages not specifically recited herein.

Alterations and permutations of the preferred embodiments and methods will become apparent to those skilled in the art upon a reading of the specification and a study of the appendices and drawings. In variations where the benefits of satellite-based fire alert detection are not required, for example, a ground-based area observation type of alert detection can be employed.

Accordingly, none of the disclosure of the preferred embodiments and methods defines or constrains the invention. Rather, the issued claims variously define the invention. Each variation of the invention is limited only by the recited limitations of its respective claim, and equivalents thereof, without limitation by other terms not present in the claim.

In addition, aspects of the invention are particularly pointed out in the claims using terminology that the inventors regard as having its broadest reasonable interpretation; the more specific interpretations of 35 U.S.C. § 112(6) are only intended in those instances where the terms “means” or “steps” are actually recited.

The words “comprising,” “including,” and “having” are intended as open-ended terminology, with the same meaning as if the phrase “at least” were appended after each instance thereof. A clause using the term “whereby” merely states the result of the limitations in any claim in which it may appear and does not set forth an additional limitation therein. Both in the claims and in the description above, the conjunction “or” between alternative elements means “and/or,” and thus does not imply that the elements are mutually exclusive unless context or a specific statement indicates otherwise.

1. A structure comprising an elongated tube comprised of material that is water-porous throughout on one side of the tube and material that is water-impermeable on the remainder of the tube.

2. The structure of claim 1 further comprising a plurality of fasteners coupling the tube to a substantially vertical exterior wall of a structure with the water-porous side of the tube facing the wall.

3. The structure of claim 2 further comprising a elongated flat lip integral to and extending from the tube along its entire length, wherein the tube is mounted to the wall using only fasteners passing through the lip.

4. The structure of claim 3 wherein the lip extends from the bottom of the tube as it is mounted to the wall.

5. The structure of claim 1 further comprising a flat lip integral to and extending from the tube.

6. The structure of claim 1 wherein the tube is elliptical in cross-section.

7. The structure of claim 6 wherein the tube is indented at the middle of the water-impermeable side.

8. The structure of claim 1 wherein the water-impermeable material spans more than half of the tube's circumference.

9. The structure of claim 8 wherein the water-impermeable material spans about 54% of the tube's circumference.

10. The structure of claim 1 wherein the tube is comprised of low-density polyethylene.

11. The structure of claim 10 wherein the water-porous side of the tube is comprised of a material that has a lower average polyethylene content than the water-impermeable side of the tube.

12. The structure of claim 10 wherein the tube is comprised of substantially uniform material throughout its circumference, except that the water-impermeable side of the tube has a water-impermeable coating thereon.

13. The structure of claim 12 wherein the water-impermeable coating consists substantially of low-density polyethylene.

14. The structure of claim 1 wherein the tube is substantially comprised of an extruded mixture of granulated tire rubber, low-density polyethylene, and carbon black.

15. The structure of claim 14 further comprising an elongated flat lip integral to and extending from the tube along its entire length, wherein:
(a) the tube is elliptical in cross-section and is indented at the middle of the water-impermeable side;
(b) the water-impermeable material spans more than half of the tube's circumference; and
(c) the tube and the lip are comprised of substantially uniform material, except that the water-impermeable side of the tube has a water-impermeable coating thereon substantially consisting of low-density polyethylene.

16. The structure of claim 15 wherein the tube is mounted to a substantially vertical exterior wall of a structure using only fasteners passing through the lip, and wherein the lip extends from the bottom of the tube as it is mounted to the wall.

17. A method for trying to prevent a wildfire from consuming a structure comprising mounting to a substantially vertical exterior wall of a structure an elongated tube having a water-porous portion facing towards the wall and a water-impermeable portion facing away from the wall.

18. The method of claim 17 wherein mounting includes driving fasteners through an elongated flat lip, integral to and extending from the tube along its entire length, and into the wall.

19. The method of claim 18 wherein mounting includes first orienting the tube with the lip extending from the bottom of the tube as it is mounted to the wall.

20. The method of claim 19 wherein mounting includes using an elongated tube that:
(a) is elliptical in cross-section and is indented at the middle of the water-impermeable side;
(b) has water-impermeable material spanning more than half of the tube's circumference; and
(c) is made of substantially uniform material, except that the water-impermeable side of the tube has a water-impermeable coating thereon substantially consisting of low-density polyethylene.

21. The method of claim 18 further comprising pressurizing the tube with fire-retardant fluid such that the fluid migrates through the water-porous side and onto the wall, substantially along the entire length of the tube.

22. The method of claim 21 wherein pressurizing the tube comprises pressurizing the tube with a mixture of fire retardant and water.

23. The method of claim 21 further comprising monitoring for a fire alert and generating a signal upon detection of a fire alert condition, and automatically pressurizing the tube in response to generation of the signal.

24. The method of claim 23 wherein monitoring occurs at a location remote from the structure and wherein automatically pressuring the tube is performed in response to the generation and transmission of the signal from the remote location.

25. The method of claim 24 wherein monitoring comprises observing satellite images of a geographic area including the structure.

26. A method of manufacturing a tube comprising forming an elongated tube comprised of material that is water-porous throughout on one side of the tube and material that is water-impermeable on the remainder of the tube.

27. The method of claim 26 wherein forming comprises extruding the tube.

28. The method of claim 27 further comprising coating one side of the extruded tube with a water-impermeable coating to form the water-impermeable side.

29. The method of claim 26 further comprising integrally forming a elongated flat lip extending from the tube along its entire length.

30. The method of claim 29 wherein forming comprises extruding the tube and the lip simultaneously.

31. The method of claim 26 wherein the tube is elliptical in cross-section and indented at the middle of the water-impermeable side.

32. The method of claim 26 wherein forming the tube comprises forming the tube of a material including low-density polyethylene.

33. The method of claim 32 wherein forming the tube comprises forming the tube substantially of an extruded mixture of granulated tire rubber, low-density polyethylene, and carbon black.

34. A wildfire monitoring and service method comprising:
(a) at a central location, monitoring satellite images of a geographic area including a plurality of space-separated structures for indicia of wildfires, including at least periodically tracking the location of the wildfires; and
(b) for each of the structures:
(1) comparing the monitored indicia of wildfires with the structure's location,
(2) generating a signal when the structure appears to be in danger from a monitored one of the wildfires,
(3) wirelessly transmitting the signal from the central location to the structure, and
(4) applying the signal to automatically trigger application of fire-retardant fluid to select exterior faces of the structure.

35. The method of claim 34 wherein parts (a) and (b)(1) are done automatically.

36. The method of claim 34 wherein part (b)(2) comprises generating the signal when a monitored one of the wildfires closes to within a predetermined threshold distance of the structure.

37. The method of claim 34 wherein part (a) further includes at least periodically tracking the direction and speed of travel of a front of the wildfire.

38. The method of claim 37 wherein part (b)(2) comprises generating the signal when a monitored one of the wildfire fronts closes to within a predetermined threshold predicted time from reaching the structure, wherein the predicted time from reaching the structure is calculated from the tracked location, direction, and speed of travel.

39. The method of claim 34 wherein part (b)(4) comprises applying the signal to automatically trigger pressurization with fire-retardant fluid of an elongated tube having a water-porous portion facing towards the wall and a water-impermeable portion facing away from the wall mounted to a substantially vertical exterior wall of the structure.

40. The method of claim 39 wherein pressurization of the tube comprises pressurizing the tube with a fluid mixture of fire retardant and water.

41. A wildfire monitoring and service system comprising:
(a) at a central location, a satellite-image monitoring computer programmed to display a composite map image defining the locations of (1) wildfires observed by satellite, and (2) a plurality of space-separated structures;
(b) a wireless transmission subsystem capable of transmitting a signal from the central location selectively to each of the structures; and
(c) at each of the structures, a fire-retardant application subsystem directed at exterior surfaces of the structure and responsive to a select signal transmitted through the transmission subsystem.

42. The system of claim 41 wherein the wireless transmission subsystem is automatically responsive to calculations by the computer determining that one of the wildfires observed by the satellite is closer to one of the structures than a predetermined threshold distance.

43. The system of claim 41 wherein the fire-retardant application subsystem at each of the structures comprises an elongated tube having a water-porous portion facing towards the wall and a water-impermeable portion facing away from the wall mounted to a substantially vertical exterior wall of the structure and coupled to a water source.

44. The system of claim 43 wherein the tube is further coupled to a source of fire retardant and wherein the couplings to the water source and the source of fire retardant are such that the water and fire retardant passes through the fire-retardant application subsystem as a mixture.

45. The system of claim 44 wherein the fire-retardant application subsystem further includes a backflow valve positioned to prevent fire retardant from contaminating the water source.

46. The system of claim 41 wherein the fire-retardant subsystem at each of the structures comprises a plurality of spray outlets coupled to a water source and capable of directing water at downward-facing exterior surfaces of the structure.

47. The system of claim 46 wherein the fire-retardant subsystem at each of the structures further comprises an elongated tube mounted to a substantially vertical exterior wall of the structure, coupled to the water source, and having a water-porous portion facing towards the wall and a water-impermeable portion facing away from the wall.

48. The system of claim 47 wherein the tube and the spray outlets have a common inlet, and wherein the inlet is coupled both to the water source and to a source of fire retardant, and wherein the couplings to the water source and the source of fire retardant are such that the water and fire retardant passes through the fire-retardant application subsystem as a mixture.

49. The system of claim 48 wherein the fire-retardant application subsystem further includes a backflow valve positioned to prevent fire retardant from contaminating the water source.

50. The system of claim 49 wherein:
(a) the tube is elliptical in cross-section and further has an elongated flat lip integral to and extending from the tube along its entire length;
(b) the tube and the lip are substantially comprised of a substantially uniform, extruded mixture of granulated tire rubber, low-density polyethylene, and carbon black, with a water-impermeable coating substantially consisting of low-density polyethylene spanning more than half but less than all of the tube's circumference; and
(c) the tube is mounted to the wall using only fasteners passing through the lip, which lip extends from the bottom of the tube as it is mounted to the wall.
